(19) United States
(12) Patent Application Publication
(10) Pub. No.: US 2003/0145123 A1
(43) Pub. Date: Jul. 31, 2003

(54) Method, system, and program for providing access to an application on an end user computer

(75) Inventors: Becky Berndt, Broomfield, CO (US); Daniel J. Maslowski, Erie, CO (US); Paul Von Behren, Boulder, CO (US)

Correspondence Address: David W. Victor, KONRAD RAYNES VICTOR & MANN LLP, Suite 210, 315 Beverly Drive, Beverly Hills, CA, 90212, US

(73) Assignee: Sun Microsystems, Inc.

(21) Appl. No.: 10/062,040

(22) Filed: Jan. 31, 2002

(51) Int. Cl. G06F 9/00; G06F 9/54; G06F 15/163

(52) U.S. Cl. 709/310

(57) ABSTRACT

Provided are a method, system, and program for generating an installation package for an application. The application is intended to execute on an operating system of an end user computer. A translator program installed on the end user computer converts code in the application to native operating system commands. Provided are the application and a launcher program including code to perform operations on an end user computer including the operating system to launch the application. A launcher application including code to call the launcher program is accessed.

### BACKGROUND OF THE INVENTION

1. Field of the Invention

The present invention relates to a method, system, and program for providing access to an application on an end user computer.

2. Background of the Invention

Certain types of application programs do not execute directly in an operating system environment. For instance, an application program written in the Java** programming language cannot execute directly in a Microsoft Windows** operating system (Windows) environment. A Java application program is comprised of source files that are compiled into bytecodes. The Java Virtual Machine (JVM) interprets the bytecodes to produce native operating system commands, such as those executable by Windows, so that the operating system may execute the Java application. An application program written in the Java programming language typically has an extension “java” and the corresponding compiled file has an extension “.class.” For example, a source file “x.java” may be compiled into an application “x.class”. **UNIX is a registered trademark of The Open Group; Java is a trademark of Sun Microsystems, Inc.; Microsoft and Windows are trademarks of Microsoft Corporation; InstallShield is a trademark of the InstallShield Software Corporation.

Typically PATH and CLASSPATH variables are set within an operating system before running the Java application. The PATH variable is set so that the if a user wants to run the Java compiler via the command “javac.exe” without having to type the full path of the command “javac.exe”. If the PATH variable is not set, then the user may have to specify the full directory path to an executable every time the user wants to run the executable. For instance, the user would have to enter the command “C:\>jdk1.3.1\bin\javac x.java” to run the Java compiler “javac.exe” on the Java application program “x.java” and create the class file “x.class”. Variables, such as PATH and CLASSPATH may be changed in various ways such as by editing batch files, registry entries, via system configuration utilities etc.

Since Java bytecodes can run on any machine with a Java interpreter, i.e., a Java Virtual Machine, in most situations an end user would run a Java program that has already been compiled. An end user may go to a command line interface, such as a command prompt in the Microsoft Windows operating system environment, and execute the standalone Java application within the Java interpreter (e.g. the command “C:>\java x.class” to run the “x.class”). The CLASSPATH variable tells the Java interpreter where to find third-party and user-defined classes, i.e. classes that are not Java extensions or part of the Java platform. The CLASSPATH is needed to find any classes compiled with the javac compiler.

For instance, the user may invoke the command prompt and type the Java classpath command to set the path to the directory where the class files are maintained, and then invoke the main method of the class through a line command (e.g. “C:>java x” would run the “x.class” file). If the classpath is not set in advance, then the Java interpreter would attempt to locate the class file in the current directory.

Another prior art technique involves end users editing their “autoexec.bat” file to set the Java classpath when the computer starts. The user may then create a desktop shortcut and edit the command line in the shortcut to include the class path and main method to execute.

A yet further prior art technique is for the end user to create a batch file that loads the Java interpreter and calls the main method of the Java application. Yet further, certain software developers provide special Java launching software tools for use in the Windows environment that generate a graphical user interface (GUI) through which a user may launch a Java application.

Notwithstanding, the above techniques still require effort and knowledge on behalf of the end user. Unsophisticated end users may be deterred from utilizing a Java application in the Windows environment due to the effort and knowledge needed to launch the Java application using prior art methods.

For these reasons, there is a need in the art to provide improved techniques for allowing developers of applications to enable the end user to launch the developers' applications when the applications cannot execute directly in the operating system environment, such as is the case with Java applications executing in a Windows environment.

### SUMMARY OF THE PREFERRED EMBODIMENTS

Provided are a method, system, and program for generating an installation package for an application. The application is intended to execute on an operating system of an end user computer. A translator program installed on the end user computer converts code in the application to native operating system commands. Provided are the application and a launcher program including code to perform operations on an end user computer including the operating system to launch the application. A launcher application including code to call the launcher program is accessed.

Yet further provided are installation code to install the application, the launcher program, and a link to the launcher application on the end user computer. The application, launcher program, launcher application, and installation code are packaged into an installation package.

In further implementations, the launcher application is renamed to have a name of the application.

Yet further, the installation code may include statements that when executed on the end user computer creates an application directory and adds the launcher program and application to the application directory.

Further provided are a method, system, and program for installing an application on an end user computer having an operating system and translator program. The translator program converts code in the application to native operating system commands. An installation package including the application, a launcher program, a launcher application, and installation code is processed. The installation code is executed to create an application directory, install the application, the launcher program, and the launcher application on the end user computer, and execute the installation code to install a link on the end user computer to the launcher application. User selection of the link is received and the launcher application associated with the selected link is executed to call the launcher program to run the application.

Still further provided are a method, program, and system for providing access to an application on an end user computer. The application is intended to execute on an operating system of the end user computer. A translator program installed on the end user computer converts the application code to native operating system commands. Provided is a launcher application including code to call a launcher program, wherein the launcher program includes code to launch the application. The translator program converts the launched application to native operating system commands to execute in the operating system. The launcher application is transmitted to a developer of the application to use to enable end users to run the application, wherein the developer renames the launcher application to a name of the application.

Described implementations provide techniques for launching applications that are not directly executed in the operating system environment and must first be converted to native operating system commands prior to execution. With described implementations, end users may launch such applications requiring conversion using a launcher application in a manner that is similar to how the user would launch applications that may be directly executed by the operating system without requiring translation.

### BRIEF DESCRIPTION OF THE DRAWINGS

Referring now to the drawings in which like reference numbers represent corresponding parts throughout:

FIG. 1 illustrates a computing environment of a developer system in which aspects of the invention are implemented;

FIG. 2 illustrates components of a launcher application in accordance with implementations of the invention;

FIG. 3 illustrates a computing environment of an end user system in which aspects of the invention are implemented;

FIG. 4 illustrates operations performed in the developer system to build an installation package in accordance with implementations of the invention;

FIG. 5 illustrates logic to execute the installation package to install an application in accordance with implementations of the invention; and

FIGS. 6 and 7 illustrate logic to launch the installed application in accordance with implementations of the invention.

### DETAILED DESCRIPTION OF THE PREFERRED EMBODIMENTS

In the following description, reference is made to the accompanying drawings which form a part hereof and which illustrate several embodiments of the present invention. It is understood that other embodiments may be utilized and structural and operational changes may be made without departing from the scope of the present invention.

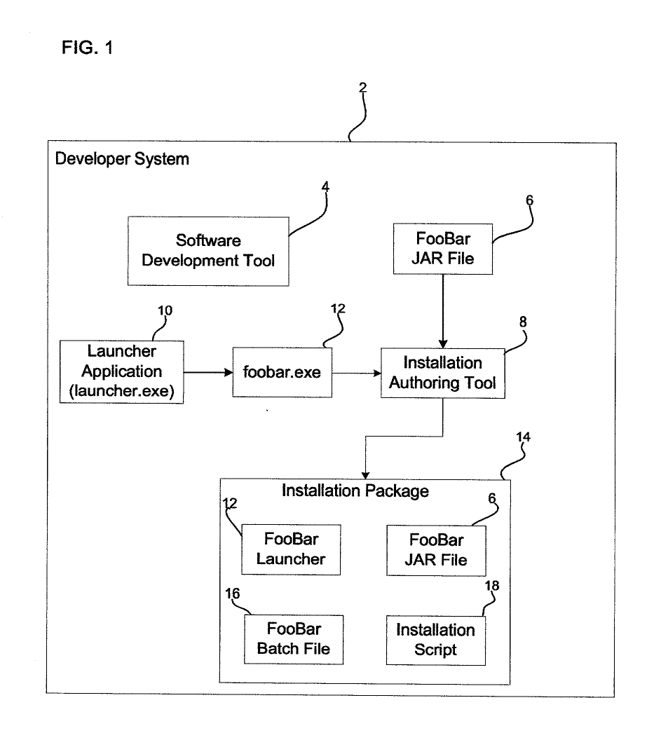

FIG. 1 illustrates a computing environment in which aspects of the invention are implemented. A developer system 2 comprises a computer used by a software developer that includes a software development tool 4 that is used to generate a Java Archive (JAR) file 6 comprising a bundle of files, including the class files and auxiliary resources associated with a Java application or applet, referred to herein as “FooBar” 6. An installation authoring tool 8 comprises a computer program that is used to generate an installation package that when executed on a computer platform will install the application included in the installation package. Examples of installation authoring tools known in the art include the InstallShield** applications, which are used to create installation packages that provide a user interface to guide the user through installing programs on Microsoft Windows operating system platforms. **UNIX is a registered trademark of The Open Group; Java is a trademark of Sun Microsystems, Inc.; Microsoft and Windows are trademarks of Microsoft Corporation; InstallShield is a trademark of the InstallShield Software Corporation.

In certain implementations, a launcher application 10 is provided. The launcher application 10 may be provided with the installation authoring 8 tool or accessed from a separate location, such as a web site. The launcher application 10 includes code described below to enable an end user to instantly and transparently execute the main method of the Java FooBar application 6 on an operating system where the FooBar application 6 does not instantaneously execute, such as the Windows operating system platforms. In the described implementations, the launcher application 10 enables the end user to execute the main method of the Java FooBar application 6 in the same manner that a Windows executable application may be invoked, such as through a program icon on the Windows “Start” menu or by selecting a program icon displayed on the desktop.

The installation package 14 further includes a FooBar batch file 16. The developer would edit the FooBar batch file 16 to include the java-classpath statement to ensure the required Java packages (the standard and application-specific packages) for the FooBar application 6 can be found and a call to the main Java method for FooBar to start the FooBar application 6. In certain implementations, the batch file 16 has a common name, e.g., “go.bat”, and is installed in the directory for the FooBar application. An installation script 16 comprises code to perform specific installation operations on an end user system as described below.

In described implementations, a developer would rename the launcher application 10 with the name of the subject Java application, e.g., launcher.exe to “FooBar.exe” 12. The developer may then use the installation authoring tool 8 to build an installation package 14 that includes the FooBar Jar file 6 and the FooBar launcher 12 (foobar.exe) to install on an end user system. FIG. 1 shows the renamed foobar application 12 being provided to the installation authoring tool 8 to include in the installation package 14.

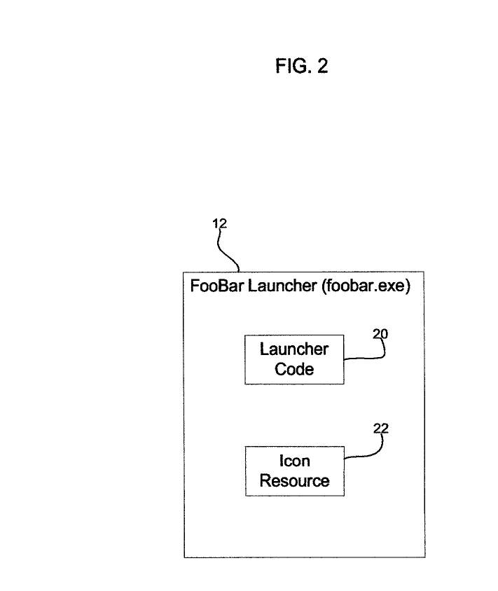

FIG. 2 illustrates further details of the foobar launcher (foobar.exe) 12, which is an executable file. The FooBar launcher 12 includes launcher code 20 to perform installation operations and an icon resource 22, which comprises an image of the icon displayed on the end user's computer desktop or in a file menu, such as the Windows “Start” menu displayed on the Windows taskbar. In certain implementations, the launcher code 20 performs the same operations on the end user system for all Java applications for which an installation package is built using the installation authoring tool 8. The launcher application 12 may come with a generic icon for display on the desktop. However, the developer may use the software development tool 4 to edit the icon resource 22 in the executable launcher file 12 to use an icon specific to the FooBar application as the icon resource 22.

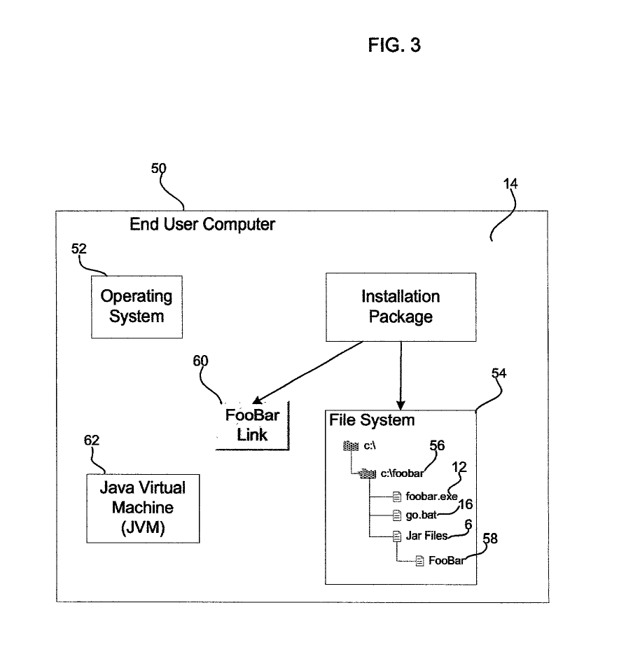

FIG. 3 illustrates a computing environment of an end user system in which aspects of the invention are implemented. An end user computer 50, which may comprise any computing device known in the art (e.g., a personal computer, mainframe, workstation, laptop, hand held computer, personal digital assistant, telephony device, network appliance, etc.), includes an operating system 52 on which the installation package 14 is capable of executing to install files related to the FooBar application 6 in a file system 54 of the end user computer 50. The application related files installed in a FooBar directory 56 in the file system 54 include the FooBar launcher 12 to allow the user to directly launch the FooBar Java application, a FooBar batch file 16 named “go.bat”, the FooBar JAR files 6 including the class files needed to implement the FooBar application, and the main FooBar method 58 that runs the FooBar application. The installation package 14 when executed on the end user computer 50 would further install a user control, such as an icon 60, or graphical link to enable the end user to execute the FooBar application as a standard application designed for the operating system 52. For instance, if the operating system 52 comprises the Windows operating system, then the installation package 14 could install an icon in the “Start” menu or on the desktop that the user may select to run the FooBar application in the same manner that the user would invoke non-Java applications that execute directly on the operating system 52 without the need of a language translator, such as a Java Virtual Machine (JVM) 62.

The end user computer further includes a Java Virtual Machine (JVM) 62 to implement the Java runtime environment and execute the FooBar and any other Java applications. The JVM 62 would translate the Java FooBar application 6 bytecodes into native commands of the operating system 52 to execute the FooBar application.

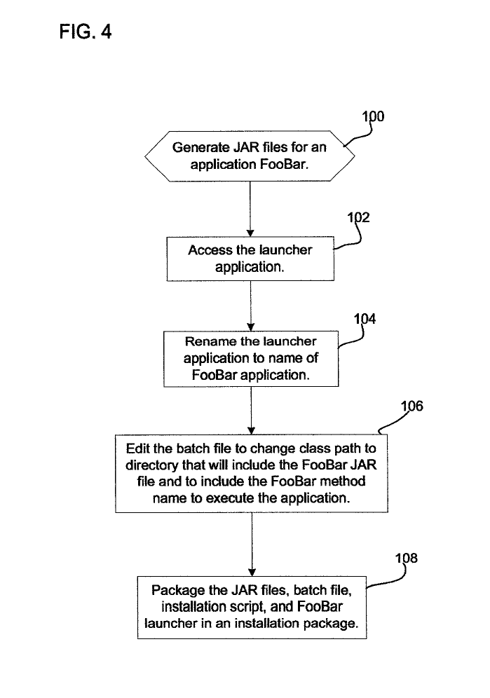

FIG. 4 illustrates operations the developer performs using the components in the developer system. At block 100, the developer would use the software development tool 4 to generate the JAR file 6 including the class files needed to implement the FooBar application, including the main FooBar method 58 to initiate the FooBar application. The developer then accesses (at block 102) the launcher application 10. The developer may access the launcher application 10 through the installation authoring tool 8, or separately from another source. For instance, a Java resource Internet web site may provide the launcher application 10 as a downloadable tool that developers can include in installation packages to provide a mechanism to enable users to invoke files directly in their operating system 52 environment as they would any other application program written for their operating system 52. The developer would then use a file system or other tool to rename (at block 104) the launcher application 10 to the name of the Java application being developed, e.g., foobar.exe 12. The developer would further edit (at block 106) the batch file to change the class path to the directory in which the class files and resources in the FooBar JAR file 6 will be installed.

The developer would then use the installation authoring tool 8 to build the installation package 14 to include all the components to install the FooBar JAR file 6 class files and to add user control to the operating system 52 to enable the user to invoke the FooBar application as the user would invoke any other application written to execute in the operating system 52. The installation package 14 may be distributed to install the FooBar application and all necessary files 6 on end user computers 50.

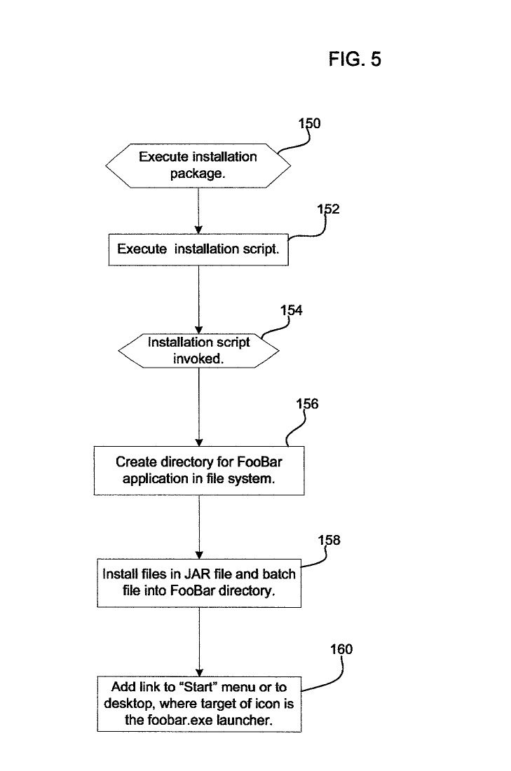

FIG. 5 illustrates logic implemented in installation package 14 and installation script 18 that is executed on the end user computer 50 to install the FooBar application components. Control begins at block 150 with the end user computer 50 executing the installation package 14. In response, the installation script 18 is called (at block 152) to install the various FooBar components. The installation script 18 runs (at block 154) and creates (at block 156) a subdirectory 56 for the FooBar application 6 in the file system 54. The subdirectory 56 may have the name of the application, e.g., “foobar”. In certain implementations, the user may be prompted to enter a location, such as a drive name, computer name, root directory, subdirectory, etc., for the foobar subdirectory 56. The installation script 18 then installs (at block 158) the FooBar class files in the JAR file 6, including the main FooBar method 58, and the batch file 16 into the FooBar subdirectory 56. The installation script 18 then adds (at block 160) a link 60 to invoke the application in the end user computer 50 environment. The link may 60 comprise an icon on the desktop or in the Windows “Start” menu, or any control the user may activate through any input device, e.g., keyboard, mouse, touch screen, voice activated commands, etc. In certain implementations, the icon displayed comprises the icon image in the icon resource 22 included in the FooBar launcher 12.

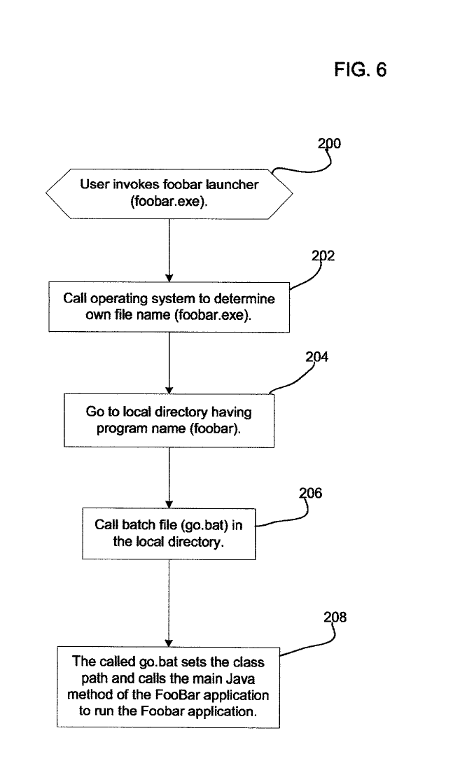

FIG. 6 illustrates logic implemented in the launcher code 20 when the user invokes the FooBar launcher 12, such as by selecting an icon or other link that calls the FooBar launcher 12 (foobar.exe). As discussed, the FooBar launcher 12, as well as associated launcher code 20, executes directly in the operating system 52 environment, without the need for any translation from the Java Virtual Machine 62. After being called (at block 200), the launcher 12 calls (at block 202) the operating system 52 for its own program name, e.g., “foobar”. Upon receiving a response, the launcher 12 then accesses (at block 204) the local directory 56 having the name of the launcher 12 returned in response to the call. The launcher 12 then calls (at block 206) the FooBar batch file 16, having the common “go.bat” file name in the accessed local FooBar directory 56. The called FooBar batch file 16 would then execute the batch file 16 code to set the class path to the foobar directory 56 that includes the FooBar class files from the FooBar Jar file 6. The batch file 16 further includes statements to call the main FooBar Java method 58 after the classpath is set to invoke and run the actual Java FooBar application.

In an alternative implementation, the installation script 18 would include code to add an entry to a registry file in the operating system 52 during installation of the application. The registry entry would include information on the batch file 16 (FIG. 3) to launch for the application being installed. For instance, in the Windows operating system, the entry may be added to the control subkey in the HKEY_LOCAL_MACHINE registry key to provide information on the installed Java application. The subkey (1) below provides an example of a registry entry added to the Windows registry file:

HKLM\SOFTWARE\APPLICATION NAME\App_Path,

where “APPLICATION NAME” is the name of the Java application being installed, e.g., FooBar, and “App_Path” is the directory location including the script file to execute, e.g., “c:\foobar” 56.

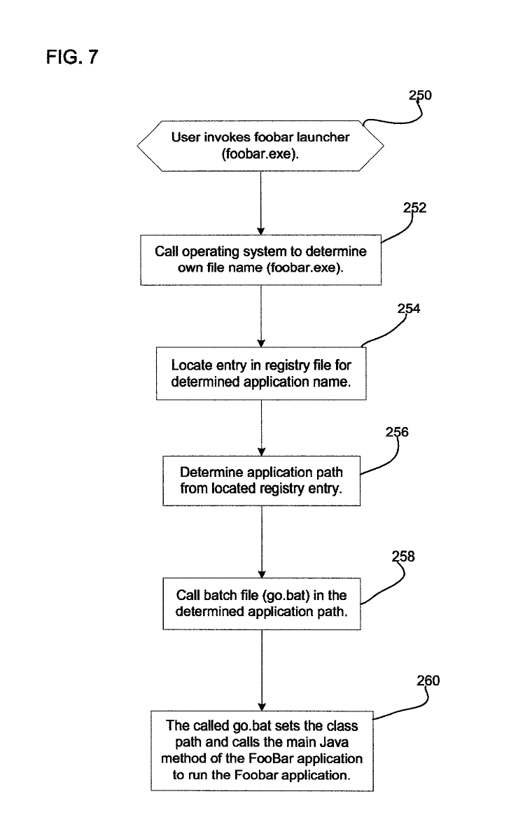

FIG. 7 illustrates alternative logic implemented in the launcher code 20 of the renamed launcher application 10, e.g., the FooBar launcher 12 (foobar.exe), when the registry is used to provide information on the Java application. At block 250, the user invokes the application launcher 12 (foobar.exe). In response, the launcher code 20 calls (at block 252) the operating system 52 (FIG. 3) to determine its own name, e.g., “foobar.exe”. The launcher code 20 would then locate (at block 254) the entry in the operating system 52 registry file having the returned application name. For instance, in the Windows operating system, the launcher code 20 would search for an entry in the HKEY_LOCAL_MACHINE section of the registry having a control subkey including the returned application name, e.g., “FooBar”. The launcher code 20 would then determine (at block 256) the application path from the “App_Path” component of the located registry entry for the application. The application batch file 16, e.g., “go.bat”, is then called (at block 258) in the subdirectory identified in the determined application path (“App_Path”) component of the located registry key. The launcher 12 then calls (at block 260) the FooBar batch file 16, having the common “go.bat” file name, in the accessed local FooBar directory 56. The called FooBar batch file 16 would then execute the batch file code to set (at block 260) the class path to the foobar directory 56 that includes the FooBar class files 6 and then call the main FooBar Java method 58 to invoke and run the actual Java FooBar application.

With the described implementations, the launcher application 10 renamed to the application name foobar.exe 12 provides an application capable of being executed directly by the operating system 52 that when invoked by the user calls batch files and performs any additional operations to set-up the environment and call an application program that does not directly run in the operating system environment 54, but instead must be invoked in a separate runtime environment, such as the Java Runtime Environment (JRE). Further, the user may invoke through a user interface the launcher program 12 to seamlessly invoke the Java application as the user would invoke any application, e.g., non-Java application, written to directly execute in the operating system 52 environment. Still further, in the described implementations, the installation package installs the launcher 12 in the operating system 52 environment just as any other application program would be installed. In this way, the user can invoke the Java application just as any other operating system application, e.g., C++ application program, would be invoked.

With the described implementations, the same launcher application 12 code is used for all Java applications. In such case, the developer need only change the name of the launcher application 12 to the Java application name, e.g., FooBar, and optionally add an application specific icon to the icon resources 22. The launcher code 20 may operate in the same manner for all Java applications, assuming that the developer installs all Java applications in the same manner, i.e., in a local directory having the application name and a batch file having a common name to launch the actual Java application in the Java Runtime Environment (JRE). This allows easy deployment of the launcher application 12 because developers can use the launcher application 12 with only having to make relatively minor editing changes.

### Additional Implementation Details

The described installation and launcher tools may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks,, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Of course, those skilled in the art will recognize that many modifications may be made to this configuration without departing from the scope of the present invention, and that the article of manufacture may comprise any information bearing medium known in the art.

In the described implementations, the developer would separately use a software development tool 4 and installation authoring tool 8 to perform certain operations described herein. The developer operations to generate the installation package described with respect to FIG. 4 may be performed by separate development tools, such as shown in FIG. 1, or alternatively performed by a single integrated development tool, or still further performed by yet additional development tools.

The operations to access and rename the launcher and edit the batch file to change the class path may be performed automatically when the user generates the installation package 14. For instance, the installation authoring tool 8 may automatically access the launcher application, rename the launcher application to a provided name of the application to install, and edit the batch file to change the class path to a directory named with the application name. Alternatively, some of these operations may be performed in response to specific user action.

The described implementations concerned Java applications that execute within a Windows operating system environment. However, the described Java implementations may apply to any operating system on which a Java runtime environment may execute to translate Java application bytecodes into native operating system commands. Additionally, the described implementations may apply to applications written in any cross-platform programming language where an operating system specific language translator converts the application code written in the cross-platform programming language to native operating system commands that are executed directly by the operating system.

In described implementations, a batch file is executed to launch the application. In alternative implementations, the batch file may comprise any type of program, applet, etc., capable of executing various statements to launch the application.

The program logic described in the flowcharts indicates certain events occurring in a certain order. Those skilled in the art will recognize that the ordering of certain programming steps or program flow may be modified without affecting the overall operation performed by the preferred embodiment logic, and such modifications are in accordance with the preferred embodiments. Additionally, certain of the steps may be performed concurrently in a parallel process when possible, as well as performed sequentially as shown in the figures.

The foregoing description of the preferred embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for generating an installation package for an application, wherein the application is intended to execute on an operating system of a computer, wherein a translator program installed on the computer converts code in the application to native operating system commands, comprising:
providing the application;
providing a launcher program including code to perform operations on the computer including the operating system to launch the application; and
accessing a launcher application including code to call the launcher program.

2. The method of claim 1, further comprising:
providing installation code to install the application, the launcher program, and a link to the launcher application on the computer; and
packaging the application, launcher program, launcher application, and installation code into an installation package.

3. The method of claim 2, further comprising:
editing the launcher application to include an icon specific to the application, wherein the icon is displayed with the link installed on the computer.

4. The method of claim 2, wherein the installation code includes statements that when executed on the computer creates an application directory and adds the launcher application, launcher program, and application to the application directory.

5. The method of claim 4, wherein the installation code further includes statements to add a key to a registry in the computer to include information on the application directory.

6. The method of claim 1, further comprising:
renaming the launcher application to have a name of the application.

7. The method of claim 1, further comprising:
editing the launcher program to reference the application.

8. The method of claim 7, wherein the application is part of an application class the installation code installs in an application directory, wherein the application class includes a main application method to run the application, and wherein editing the launcher program to reference the application further comprises:
including a statement in the launcher program to set a class path to the application directory; and
including a statement in the launcher program to call the main application method.

9. The method of claim 8, wherein the application is written in the Java computer language and wherein the translator comprises a Java Virtual Machine.

10. The method of claim 1, wherein the launcher program is executed directly by the operating system.

11. The method of claim 1, wherein the launcher program comprises a batch file.

12. The method of claim 1, wherein the translator program converts the launched application to native operating system commands to execute in the operating system.

13. A method for installing an application on a computer having an operating system and translator program, wherein the translator program converts code in the application to native operating system commands, comprising:
(a) processing an installation package including the application, a launcher program, a launcher application, and installation code;
(b) executing the installation code to perform:
(i) creating an application directory;
(ii) installing the application, the launcher program, and the launcher application on the computer; and
(iii) installing a link on the computer to the launcher application;
(c) receiving user selection of the link; and
(d) executing the launcher application associated with the selected link to call the launcher program to run the application.

14. The method of claim 13, further comprising:
creating, in response to executing the installation code, an application directory on the computer, wherein the launcher program, launcher application, and application are installed in the application directory.

15. The method of claim 14, wherein the launcher application includes a name of the application and is executed to perform:
calling the operating system to determine a name of the launcher application;
accessing the application directory including the application name; and
calling the launcher program in the accessed directory to run the application.

16. The method of claim 15, further comprising:
executing the installation code to add a key to a registry in the computer to include information on the application directory;
locating an entry in a registry having the determined name in response to executing the launcher application; and
determining the application directory from the information included in the located registry entry in response to executing the launcher application, wherein the accessed directory comprises the directory determined from the located registry entry.

17. The method of claim 13, wherein the application is part of an application class installed in an application directory, wherein the application class includes a main application method to run the application, and wherein the launcher program is executed to call the launcher program by:
executing a statement in the launcher program to set a class path to the application directory; and
executing a statement in the launcher program to call the main application method to launch the application.

18. The method of claim 17, wherein the application is written in the Java computer language and wherein the translator comprises a Java Virtual Machine.

19. The method of claim 13, wherein the launcher program is executed directly by the operating system.

20. The method of claim 13, wherein the launcher program comprises a batch file.

21. The method of claim 13, wherein the translator program converts the launched application to native operating system commands to execute in the operating system.

22. A method for providing access to an application on a computer, wherein the application is intended to execute on an operating system of the computer, wherein a translator program installed on the computer converts the application code to native operating system commands, comprising:
providing a launcher application including code to call a launcher program, wherein the launcher program includes code to launch the application, wherein the translator program converts the launched application to native operating system commands to execute in the operating system; and
transmitting the launcher application to a developer of the application to use to enable users to run the application, wherein the developer renames the launcher application to a name of the application.

23. The method of claim 22, wherein the launcher application and program are executed directly by the operating system.
editing the launcher application to include an icon specific to the application, wherein the icon is displayed with the link installed on the computer.

24. A system for generating an installation package for an application, wherein the application is intended to execute on an operating system of a computer, wherein a translator program installed on the computer converts code in the application to native operating system commands, comprising:
a computer readable medium
means for providing the application in the computer readable medium;
means for providing a launcher program including code to perform operations on the computer including the operating system to launch the application in the computer readable medium; and
means for accessing a launcher application including code to call the launcher program.

25. The system of claim 24, further comprising:
means for providing installation code in the compute readable to install the application, the launcher program, and a link to the launcher application on the computer; and
packaging the application, launcher program, launcher application, and installation code into an installation package.

26. The system of claim 24, wherein the installation code includes statements that when executed on the computer creates an application directory and adds the launcher application, launcher program, and application to the application directory.

27. The system of claim 26, wherein the installation code further includes statements to add a key to a registry in the computer to include information on the application directory.

28. The system of claim 24, further comprising:
means for renaming the launcher application to have a name of the application.

29. The system of claim 24, wherein the translator program converts the launched application to native operating system commands to execute in the operating system.

30. A system for installing an application, comprising:
a computer having an operating system and translator program, wherein the translator program converts code in the application to native operating system commands;
means for processing an installation package including the application, a launcher program, a launcher application, and installation code;
means for creating an application directory in response to executing the installation code;
means for installing the application, the launcher program, and the launcher application on the computer in response to executing the installation code; and
means for installing a link on the computer to the launcher application in response to executing the installation code;
means for receiving user selection of the link; and
means for executing the launcher application associated with the selected link to call the launcher program to run the application.

31. The system of claim 30, further comprising:
means for creating, in response to executing the installation code, an application directory on the computer, wherein the launcher program, launcher application, and application are installed in the application directory.

32. The system of claim 31, wherein the launcher application includes a name of the application, further comprising:
means for calling the operating system to determine a name of the launcher application in response to executing the launcher program;
means for accessing the application directory including the application name in response to executing the launcher program; and
means for calling the launcher program in the accessed directory to run the application.

33. A system for providing access to an application on an computer, wherein the application is intended to execute on an operating system of the computer, wherein a translator program installed on the computer converts the application code to native operating system commands, comprising:
a compute readable medium;
a launcher application in the computer readable medium;
a launcher program in the computer readable medium, wherein the launcher application includes code to call a launcher program, wherein the launcher program includes code to launch the application, wherein the translator program converts the launched application to native operating system commands to execute in the operating system; and
means for transmitting the launcher application to a developer of the application to use to enable users to run the application, wherein the developer renames the launcher application to a name of the application.

34. A system for generating an installation package for an application, wherein the application is intended to execute on an operating system of a computer, wherein a translator program installed on the computer converts code in the application to native operating system commands, comprising:
a computer readable medium;
a processor;
code implemented in the computer readable medium to cause the processor to perform:
(i) providing a launcher program including code to perform operations on the computer including the operating system to launch the application; and
(ii) accessing a launcher application including code to call the launcher program.

35. The system of claim 34, wherein the program logic further causes the processor to perform:
providing installation code to install the application, the launcher program, and a link to the launcher application on the computer; and
packaging the application, launcher program, launcher application, and installation code into an installation package.

36. A system for installing an application;
a computer having an operating system and translator program, wherein the translator program converts code in the application to native operating system commands, comprising:
a computer readable medium;
code implemented in the computer readable medium including code to cause the computer to perform:
(i) processing an installation package including the application, a launcher program, a launcher application, and installation code;
(ii) executing the installation code, wherein the installation code further causes the processor to perform:
(a) creating an application directory;
(b) installing the application, the launcher program, and the launcher application on the computer; and
(c) installing a link on the computer to the launcher application;
(iii) receiving user selection of the link; and
(iv) executing the launcher application associated with the selected link to call the launcher program to run the application.

37. The system of claim 36, wherein the installation code further causes the processor to perform:
creating an application directory on the computer, wherein the launcher program, launcher application, and application are installed in the application directory.

38. An article of manufacture including code for generating an installation package for an application, wherein the application is intended to execute on an operating system of a computer, wherein a translator program installed on the computer converts code in the application to native operating system commands, wherein the code causes operations to be performed, the operations comprising:
providing the application;
providing a launcher program including code to perform operations on the computer including the operating system to launch the application; and
accessing a launcher application including code to call the launcher program.

39. The article of manufacture of claim 38, further comprising:
providing installation code to install the application, the launcher program, and a link to the launcher application on the computer; and
packaging the application, launcher program, launcher application, and installation code into an installation package.

40. The article of manufacture of claim 39, further comprising:
editing the launcher application to include an icon specific to the application, wherein the icon is displayed with the link installed on the computer.

41. The article of manufacture of claim 39, wherein the installation code includes statements that when executed on the computer creates an application directory and adds the launcher application, launcher program, and application to the application directory.

42. The article of manufacture of claim 41, wherein the installation code further includes statements to add a key to a registry in the computer to include information on the application directory.

43. The article of manufacture of claim 38, further comprising:
renaming the launcher application to have a name of the application.

44. The article of manufacture of claim 38, further comprising:
editing the launcher program to reference the application.

45. The article of manufacture of claim 44, wherein the application is part of an application class the installation code installs in an application directory, wherein the application class includes a main application method to run the application, and wherein editing the launcher program to reference the application further comprises:
including a statement in the launcher program to set a class path to the application directory; and
including a statement in the launcher program to call the main application method.

46. The article of manufacture of claim 45, wherein the application is written in the Java computer language and wherein the translator comprises a Java Virtual Machine.

47. The article of manufacture of claim 38, wherein the launcher program is executed directly by the operating system.

48. The article of manufacture of claim 38, wherein the launcher program comprises a batch file.

49. The article of manufacture of claim 38, wherein the translator program converts the launched application to native operating system commands to execute in the operating system.

50. An article of manufacture including an installation packing including code to install an application on a computer having an operating system and translator program, wherein the translator program converts code in the application to native operating system commands, wherein the installation package comprises:
the application, a launcher program, a launcher application, and installation code;
wherein the installation code causes operations to be performed, wherein the operations comprise:
(i) creating an application directory;
(ii) installing the application, the launcher program, and the launcher application on the computer; and
(iii) installing a link on the computer to the launcher application, wherein user selection of the link causes execution of the launcher application associated with the selected link to call the launcher program to run the application.

51. The article of manufacture of claim 50, wherein the installation code further causes operations to be performed comprising:
creating an application directory on the computer, wherein the launcher program, launcher application, and application are installed in the application directory.

52. The article of manufacture of claim 51, wherein the launcher application includes a name of the application and the launcher application further includes code that causes operations to be performed comprising:
calling the operating system to determine a name of the launcher application;
accessing the application directory including the application name; and
calling the launcher program in the accessed directory to run the application.

53. The article of manufacture of claim 52,
wherein the installation code further causes operations to be performed comprising adding a key to a registry in the computer to include information on the application directory;
wherein the launcher application further includes code to cause operations comprising:
(i) locating an entry in a registry having the determined name; and
(ii) determining the application directory from the information included in the located registry entry, wherein the accessed directory comprises the directory determined from the located registry entry.

54. The article of manufacture of claim 52, wherein the application is part of an application class installed in an application directory, wherein the application class includes a main application method to run the application, and wherein the launcher program includes code to cause operations to be performed comprising:
setting a class path to the application directory; and
calling the main application method to launch the application.

55. The article of manufacture of claim 54, wherein the application is written in the Java computer language and wherein the translator comprises a Java Virtual Machine.

56. The article of manufacture of claim 50, wherein the launcher program is executed directly by the operating system.

57. The article of manufacture of claim 50, wherein the launcher program comprises a batch file.

58. The article of manufacture of claim 50, wherein the translator program converts the launched application to native operating system commands to execute in the operating system.

59. An article of manufacture including code for providing access to an application on a computer, wherein the application is intended to execute on an operating system of the computer, wherein a translator program installed on the computer converts the application code to native operating system commands, wherein the article of manufacture includes:
a launcher application;
a launcher program, wherein the launcher program includes code to call a launcher program, wherein the launcher program includes code to launch the application, wherein the translator program converts the launched application to native operating system commands to execute in the operating system; and
transmitting the launcher application to a developer of the application to use to enable users to run the application, wherein the developer renames the launcher application to a name of the application.
